(19) United States
(12) Patent Application Publication
(10) Pub. No.: US 2026/0328229 A1
(43) Pub. Date: Oct. 22, 2026

(54) THERMAL MANAGEMENT METHOD FOR A HYDRAULIC CIRCUIT OF AN AGRICULTURAL OR WORK VEHICLE AND A CONTROL UNIT IMPLEMENTING THE METHOD

(71) Applicant: CNH INDUSTRIAL ITALIA S.P.A., Turin (IT)

(72) Inventors: ADRIANO GARRAMONE, Lecce (IT); STEFANO LIBERTI, Lecce (IT); ANDREA GRAVILI, Lecce (IT)

(73) Assignee: CNH INDUSTRIAL ITALIA S.P.A., Turin (IT)

(21) Appl. No.: 19/653,684

(22) Filed: Apr. 21, 2026

(30) Foreign Application Priority Data
Apr. 22, 2025 (IT) 102025000009036

(51) Int. Cl. F15B 21/0427; E02F 9/22

(52) U.S. Cl. CPC F15B 21/0427; E02F 9/2228; F15B 2211/50518; F15B 2211/6343

(57) ABSTRACT

Method of controlling the heating of the hydraulic oil of an agricultural or work vehicle, wherein the vehicle is equipped with an articulated arm connected to a frame of the vehicle such as to assume a plurality of operating configurations, a hydraulic circuit comprising a source of pressurised hydraulic oil and a collection tank and at least one auxiliary hydraulic circuit comprising a valve for supplying an auxiliary user, a man/machine interface device for enabling a heating function of the hydraulic oil by laminating hydraulic oil through said auxiliary circuit.

### CROSS-REFERENCE TO RELATED APPLICATION

The present disclosure is based upon and claims priority to Italian patent application IT 102025000009036 filed on Apr. 22, 2025. The entire disclosure of the Italian patent application, including specifications, drawings, and claims are incorporated herein by reference in their entirety.

### TECHNICAL FIELD

The present disclosure relates generally to a method of thermal management of a hydraulic circuit of an agricultural or work vehicle and a control unit implementing the method. The vehicle can be equipped with a thermal or electric prime mover.

### BACKGROUND

Agricultural or work vehicles are equipped with at least one working part, such as an arm or a lift, and a transmission that has the purpose of allowing the vehicle to be moved.

The transmission can be driven by a prime mover, generally an internal combustion engine, although in recent years vehicles have been developed in which the prime mover is defined by an electric motor.

A directional valve is arranged to connect one of the opposing chambers of a hydraulic actuator to a source of pressurized hydraulic oil and at the same time the other chamber to a hydraulic oil collection tank, generally set at low pressure, i.e., at ambient pressure.

After the vehicle reaches the workstation, the hydraulic functions are activated to allow the movement of the hydraulic parts, such as an articulated arm, but if the oil temperature is very low, there is a risk of damaging the hydraulic circuit.

In fact, in cold climates, e.g., in the winter, the oil temperature can drop well below zero, with a significant change in oil viscosity and a consequent increase in operating pressures.

Some work vehicles are equipped with so-called auxiliary functions. These are essentially an auxiliary hydraulic port available to devices other than an articulated arm. For example, an auxiliary device can be a rotating brush to be connected to the articulated arm for cleaning the road.

Auxiliary functions can be activated by a button or more often by a wheel located at the top of the lever of a joystick located in a vehicle control cabin.

A so-called “MEM” function is also known, that is, a function that can be activated by a button that, when activated, keeps the directional valve that controls the flow of hydraulic oil through the auxiliary hydraulic port in a fully open condition and at the same time, in the case of an electric vehicle, keeps the prime mover at maximum rpm (or a high rpm).

In the case of an electric vehicle, the prime mover that activates the hydraulic pump that supplies the hydraulic circuit is electric.

If no auxiliary device is connected to the auxiliary port, this implies that the auxiliary hydraulic port is closed. Therefore, the complete opening of the corresponding directional valve means that all the hydraulic flow cannot be discharged directly into a relative accumulation tank, it is laminated through an overpressure valve connected between the delivery line that connects the hydraulic pump and the directional valve group.

This lamination of the hydraulic oil causes a sudden increase in the temperature of the hydraulic oil, as all the pumping energy is dissipated as heat.

For this reason, the MEM function must remain active for a short time, as the hydraulic circuit is equipped with a radiator to dissipate only a part, approximately 30%, of the energy converted into heat compared to the maximum energy available. This depends on the fact that, when sizing the radiator, it is considered that only a part of the energy is dissipated as heat as the oil flow is used to move the hydraulic functions. Furthermore, it is considered that the oil flow laminates through the overpressure valve for only a short period of time and therefore the heat that the radiator is unable to dissipate causes the oil temperature to increase within the limit allowed by the design specifications.

Therefore, if the MEM function is left active for too long, there is a risk of damage to the vehicle's hydraulic circuit. Consequently, the operator must have a certain sensitivity in using the MEM function for the purpose of heating the hydraulic oil.

When the vehicle is electric, the electric prime mover is activated in response to a deflection of the joystick lever with respect to a rest position. Furthermore, the rotation speed of the prime mover is a function of the deflection angle of the joystick lever. This behavior is hereinafter referred to as the “normal operating condition” of the prime mover or, equivalently, of the hydraulic pump that supplies the hydraulic circuit for actuating the hydraulic functions.

Unless specifically excluded in the detailed description that follows, the description in this chapter is to be considered as an integral part of the detailed description.

The present disclosure is directed to overcoming one or more of the above-mentioned challenges.

### SUMMARY

Inventive concepts described in the present disclosure are related to facilitate the procedure for heating hydraulic oil in an agricultural or work vehicle equipped with hydraulic devices and tools.

Inventive concepts described in the present disclosure are related to implementing a hydraulic oil heating function that, in the absence of a device connected to the auxiliary hydraulic port, activates the prime mover to which the hydraulic pump of the hydraulic circuit is connected to the maximum number of revolutions and at the same time opens the directional valve that supplies the auxiliary hydraulic port to the maximum opening as long as the temperature is below a settable temperature threshold.

In some embodiments, the hydraulic circuit is of the open center type.

In some embodiments, a maximum temperature threshold is set, beyond which, the directional valve that supplies the auxiliary hydraulic port is automatically closed or its opening is reduced and any automatic function that maintains the hydraulic pump at its maximum rotation speed is deactivated.

These and other purposes are achieved by means of the attached claims, which describe some example embodiments of the present inventive concepts, forming an integral part of the present description.

### BRIEF DESCRIPTION OF DRAWINGS

Some example embodiments of inventive concepts are best understood with reference to the accompanying drawings, in which:

FIG. 1 illustrates a hydraulic circuit of an agricultural or work vehicle modified according to some example embodiments;

FIG. 2 illustrates an implementation flow chart of the method according to some example embodiments; and

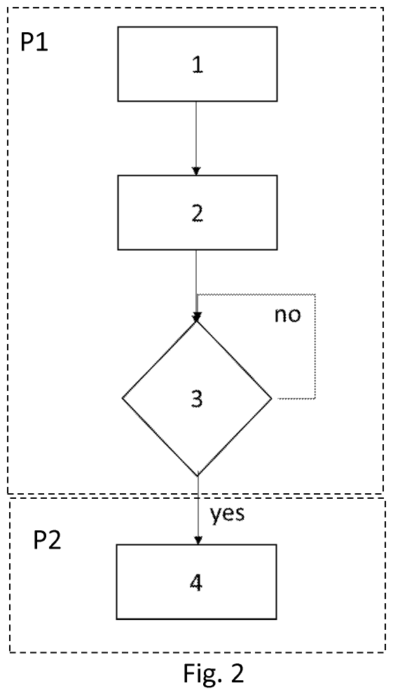

FIG. 3 illustrates a work machine comprising the hydraulic circuit of FIG. 1.

The same reference numbers and letters in the Figs. designate equal or functionally equivalent parts.

In the following detailed description, the term “second element” does not imply the presence of a “first element”, first, second, etc., they are used as labels to improve the clarity of the description and should not be interpreted in a limitative manner.

### DETAILED DESCRIPTION

Some embodiments will now be described with reference to the drawings. The detailed description does not limit the scope of the present inventive concepts, which are defined by the appended claims.

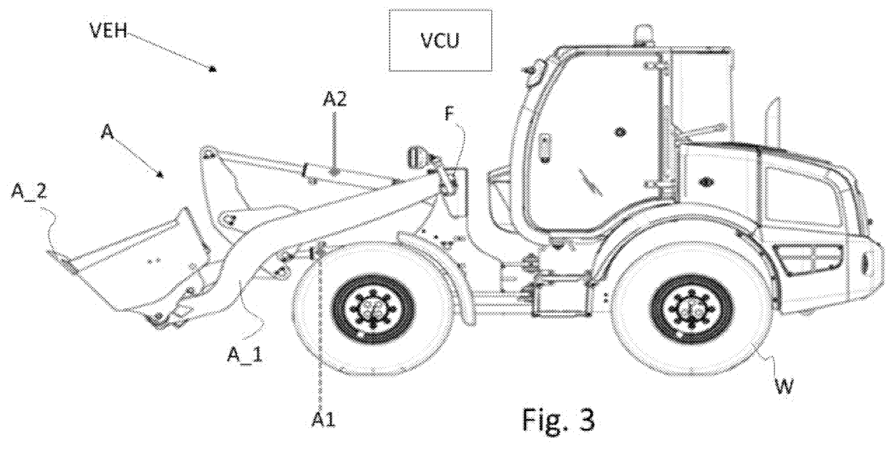

FIG. 3 illustrates a construction vehicle such as a wheel loader VEH equipped with an arm A including a first element A_1, substantially elongated, hinged to the vehicle frame F and a second element A_2, such as a bucket or a fork, hinged to the first element. More specifically, a first end of the first element A_1 is connected to the vehicle frame F, while a second end, opposite to the first one, supports the second element.

The first element can assume multiple angular positions with respect to the frame F.

The vehicle is preferably equipped with rubber wheels W but could also be equipped with tracks.

The hydraulic actuator A1 is arranged to control the angular position of the first element A_1 with respect to the vehicle frame.

The hydraulic actuator A2 is arranged to control the angular position of the second element A_2 with respect to the first element A_1.

The hydraulic actuators A1, A2 are of the double-action type, with two opposing chambers separated by a mobile partition integral with the stem of the respective actuator.

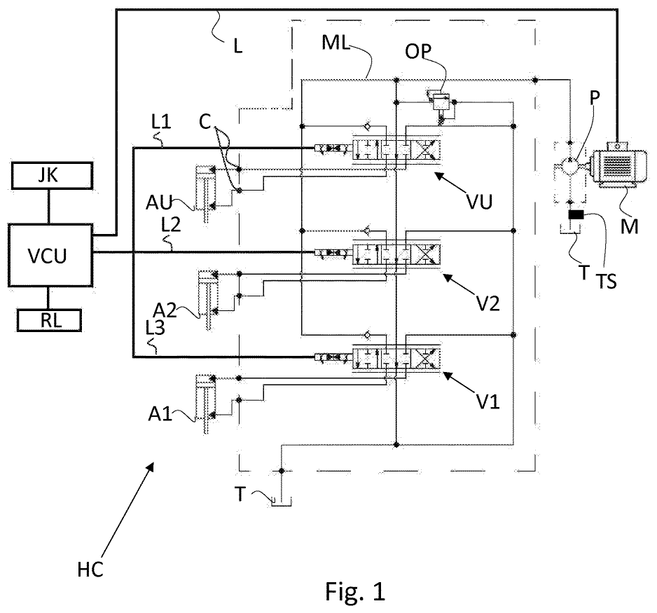

With reference to the hydraulic circuit HC shown in FIG. 1, a first electro-hydraulic valve V1 is arranged to control the connection of each of said opposing chambers of the actuator A1 alternatively with a source of hydraulic oil P or with the collection tank T of the hydraulic oil.

The first valve is therefore arranged to control the lifting or lowering of the arm A_1.

Generally, when a chamber is connected to the source P of hydraulic oil, the opposite chamber is connected to the collection tank. This allows the articulated arm to be raised or lowered. However, when the arm is stationary, e.g., in static conditions, and at least partially raised, the first chamber of the hydraulic actuator is kept pressurized and closed, e.g., disconnected from both the source of hydraulic oil and the collection tank.

A second electro-hydraulic valve V2 is arranged to control the connection of each of said opposing chambers of the actuator A2 alternatively with a source of hydraulic oil P or with the hydraulic oil collection tank T.

The second valve is therefore arranged to control the oscillation of the bucket A_2 with respect to the arm.

A third electro-hydraulic valve VU is arranged to control the connection, via an auxiliary hydraulic port C, of each of the opposing chambers of a generic hydraulic device AU connectable with the auxiliary hydraulic port C, alternatively with the source of hydraulic oil P or with the hydraulic oil collection tank T.

The third valve is therefore arranged to control a generic hydraulic device AU connectable with the auxiliary hydraulic port C.

When the auxiliary hydraulic device is disconnected, the auxiliary hydraulic port C closes automatically.

The activation of the valves V1, V2 is controlled by a human/machine interface device, such as a joystick JK, shown schematically in FIG. 1.

Similarly, a human/machine interface device, such as a wheel RL, generally associated with the lever of the joystick JK, allows to control the operation of the electro-hydraulic valve VU.

The joystick JK and the wheel RL are electrically connected to a processing unit VCU. The processing unit VCU is configured to receive an electrical signal generated by the human/machine interface devices and to control the valves V1, V2, VU. The control valves V1, V2, and VU are electro-hydraulic valves, but example embodiments are not limited thereto. The electrical lines L1-L3 for the control of the valves V1, V2, VU respectively are visible in FIG. 1.

The electrical line L is instead used by the VCU to control the hydraulic pump P or more specifically a prime mover M arranged to drive the hydraulic pump P in rotation.

The prime mover can be a dedicated electric motor, e.g., connected only to the hydraulic pump P. Or, the prime mover can be a thermal engine.

Valves V1, V2, VU are open-center directional valves. Therefore, the flow of hydraulic oil generated by the hydraulic pump P is distributed by valves V1, V2, VU between the corresponding users and the collection tank T.

A delivery line ML connects the hydraulic pump P with the valve group V1, V2, VU to supply them in parallel. Generally, an overpressure valve OP connects the delivery line ML with the collection tank T when the pressure inside the delivery line exceeds a predetermined pressure threshold. This can happen, for example, when an actuator A1, A2, AU is at the end of its stroke, or when, as in the case where valve VU is opened and no device is connected to the auxiliary hydraulic port C. In fact, port C closes automatically when no device is connected to it. For example, this means that the hydraulic oil flow is not discharged directly to the collection tank T from the valve VU but through the relief valve, converting the pumping energy into heat.

According to some embodiments, the processing unit VCU is configured to activate a “hydraulic oil heating” operating condition HT in which the valve VU is fully open and the hydraulic pump is operated so as to generate a hydraulic oil flow exceeding a predetermined flow threshold.

Such an operating condition can be activated, for example, by means of a button (or by pressing a button) on a vehicle dashboard or by means of a virtual button (or by pressing a virtual button) on a touch display on the dashboard of the VEH vehicle.

According to some embodiments, the hydraulic circuit HC comprises a temperature sensor TS arranged so as to measure a temperature value of the hydraulic oil and operationally connected to the processing unit VCU.

The processing unit VCU is configured to deactivate the operating condition HT in response to the reaching/exceeding of a first predetermined temperature value measured by said temperature sensor.

It is implied that the “hydraulic oil heating” operating condition HT can be activated only if the hydraulic oil temperature is lower than the first predetermined temperature value.

In other words, a control over the hydraulic oil temperature is implied in a first step (or operation) to allow the activation of the heating function.

Likewise, if such function can be activated by means of (or by pressing) a button by the human operator, a step is implied in which the processing unit VCU recognizes the operation of such button.

In some embodiments, such first predetermined temperature value is settable, for example in a threshold of 55-70 °C

In some embodiments, the processing unit VCU is configured not only to deactivate the HT operating condition, but further to force the VU valve to close and to force a reduction in the flow rate generated by the hydraulic pump in response to reaching a second fixed temperature value, for example 90 °C. In particular, the processing unit VCU is configured to force the flow rate of hydraulic oil to be reduced below a second flow rate threshold that is lower than the first threshold.

If the first flow rate threshold is between 90% and 99% of the maximum flow rate that can be generated by the hydraulic pump, the second flow rate threshold is less than 40% of the maximum flow rate value.

This is particularly advantageous, since, even if a different operating functionality can be activated that leads to high flow rates and to the opening of the VU valve, then by forcing the valve to close and reducing the flow rate generated by the hydraulic pump, for example, to 30% of the maximum flow rate, this different operating functionality is automatically exceeded and bypassed, safeguarding the integrity of the hydraulic circuit.

Alternatively, the hydraulic circuit is forced to operate in “normal conditions”, e.g., the flow rate of the hydraulic pump is zero or minimal if the joystick lever is released.

The hydraulic circuit is generally equipped with a radiator to cool the hydraulic oil circulating in it. In some embodiments, the temperature sensor TS is associated with the radiator and preferably with the radiator port, according to a direction of circulation of the hydraulic oil or preferably it is associated inside the collection tank T.

From a methodological point of view it can be summarized as follows:

### Phase 1 (P1)

Step 1: activation of the heating function comprising:
   Step 2: complete opening of said valve and activation (or simultaneous activation) of the hydraulic pump so as to generate a flow rate of hydraulic oil exceeding said first predetermined flow threshold;
Step 3: monitoring the hydraulic oil temperature, if the temperature reaches/exceeds the first temperature threshold, then

### Phase 2 (P2)

Step 4: closing the valve and reducing (or simultaneous reducing) or cancelling the flow rate generated by the hydraulic pump.

If the vehicle is electric, when no hydraulic actuator is activated, the hydraulic pump P is switched off or maintained at a rotation speed such as to generate a flow rate of approximately 5-10% of the maximum flow rate.

Preferably, when the hydraulic oil temperature equals or exceeds the second temperature value then the hydraulic pump is forced to switch off or to generate a flow rate of approximately 5-10% of the maximum flow rate, as in conditions of deactivation of all the hydraulic devices of the vehicle.

In some embodiments, the processing unit VCU comprises a first communication port for communicating with said human/machine interface RL, a second communication port for controlling said valve VU, a third communication port for controlling the hydraulic pump P, a fourth communication port for receiving a temperature signal generated by said temperature sensor TS, wherein the processing unit is configured to activate an operating condition (HT) causing the complete opening of the valve and the actuation of the hydraulic pump so as to generate a flow rate of hydraulic oil exceeding a predetermined flow threshold and to deactivate said operating condition (HT) in response to the achievement of a first predetermined temperature value measured by said temperature sensor.

In some embodiments, the processing unit VCU may include one or more memories, one or more processing circuitries, and/or one or more processors. The one or more memories may be and/or include any tangible, non-transitory, computer-readable medium configured to store a computer program including instructions (e.g., software code including instructions) which, when executed by the one or more processors, causes the one or more processors to carry out the method as described herein.

The one or more processors, circuitries, and/or memories may include hardware including logic circuits, a hardware/software combination, or a combination thereof. For example, the one or more processors, circuitries, and/or memories may include, but are not limited to, a central processing unit (CPU), an arithmetic logic unit (ALU), a digital signal processor, a microprocessor, a field programmable gate array (FGPA), a System-on-Chip (SoC), a programmable logic unit, a microcomputer, application-specific integrated circuit (ASIC), and the like.

The present inventive concepts may be advantageously implemented in a computer program comprising program code for executing one or more steps of such method, when such program is executed on a computer. For this reason, the present inventive concepts also cover such computer program and computer-readable medium comprising a recorded message, such computer-readable medium comprising program code means for executing one or more steps of such method, when such program is executed on a computer.

Many changes, modifications, variations and other uses and applications of the subject invention will be apparent to those skilled in the art after considering the specification and accompanying drawings, which describe preferred embodiments thereof as set forth in the appended claims.

The features disclosed in the background to the prior art are introduced only for a better understanding of the invention and not as a statement of the existence of the prior art. Furthermore, said features help define the context of the present inventive concepts; therefore, such features will be considered in common with the detailed description.

Further implementation details will not be described, as the person skilled in the art is able to carry out the present inventive concepts starting from the teaching of the description above.

1. A computer-operated method for thermal management of a hydraulic circuit of an agricultural or work vehicle, wherein the vehicle is equipped with:
an articulated arm connected to a chassis of the vehicle,
a hydraulic circuit comprising
a hydraulic pump for generating a flow rate of pressurized hydraulic oil,
at least one auxiliary hydraulic port,
a corresponding valve for supplying the auxiliary hydraulic port with said flow rate of pressurized hydraulic oil and
an overpressure valve operatively connected to a delivery line connecting the hydraulic pump with said valve,
a temperature sensor associated with said hydraulic circuit for measuring a temperature of a hydraulic oil circulating in the hydraulic circuit,
man/machine interface means for controlling said valve,
the method comprising a first phase comprising the activation of an operating condition comprising:
complete opening of said valve and contextual
actuation of said hydraulic pump so as to generate a flow rate of hydraulic oil exceeding a first predetermined flow threshold and
a second subsequent phase comprising:
deactivation of said operating condition in response to the achievement of a first predetermined temperature value measured by said temperature sensor.

2. The method according to claim 1, wherein said first predetermined temperature value is settable.

3. The method according to claim 2, wherein said processing unit is configured to force said hydraulic oil flow rate to decrease below a second flow rate threshold lower than said first threshold and to force said valve to close in response to a reaching of a second predetermined limit temperature value or when said first predetermined temperature value coincides with or exceeds said second predetermined limit temperature value.

4. The method according to claim 3, wherein the hydraulic circuit comprises a radiator for dissipating heat generated by an activation of said overpressure valve and by an activation of said hydraulic functions.

5. The method according to claim 4, wherein said second temperature value is fixed and defined by the vehicle manufacturer.

6. The processing unit for an agricultural or work vehicle, wherein the vehicle comprises
an articulated arm connected to a frame of the vehicle,
a hydraulic circuit comprising
a hydraulic pump for generating a flow rate of pressurized hydraulic oil,
at least one auxiliary hydraulic port,
a corresponding valve for supplying the auxiliary hydraulic port with said flow rate of pressurized hydraulic oil and
a pressure relief valve operatively connected to a delivery line connecting the hydraulic pump with said valve,
a temperature sensor for measuring a temperature of a hydraulic oil circulating in the hydraulic circuit;
human/machine interface means for controlling said valve,
wherein the processing unit comprises
a first communication port for communicating with said human/machine interface means,
a second communication port for controlling said valve,
a third communication port for controlling the hydraulic pump,
a fourth communication port for receiving a temperature signal generated by said temperature sensor,
and wherein the processing unit is configured
to activate an operating condition (HT) causing
the valve to open completely and
the hydraulic pump to operate so as to generate a flow rate of hydraulic oil exceeding a first predetermined flow threshold and
to deactivate said operating condition in response to reaching a first predetermined temperature value measured by said temperature sensor.

7. A computer program comprising computer program code means adapted to perform all the steps of claim 4, when said program is executed on a processing unit of an agricultural or work vehicle according to claim 6.

8. A computer-readable means having stored the program of claim 7.

9. Work or agricultural vehicle comprising
an articulated arm connected to a chassis of the vehicle,
a hydraulic circuit comprising
a hydraulic pump to generate a flow of pressurized hydraulic oil,
at least one auxiliary hydraulic port,
a corresponding valve to supply the auxiliary hydraulic port with said flow of pressurized hydraulic oil and
a pressure relief valve operatively connected to a delivery line connecting the hydraulic pump with said valve,
human/machine interface means for controlling said valve,
a processing unit operatively connected with said interface means, said pressure relief valve and said hydraulic pump and configured to activate an operating condition causing
the complete opening of the valve and
the actuation of the hydraulic pump so as to generate a flow rate of hydraulic oil exceeding a first predetermined flow threshold,
and wherein
the hydraulic circuit further comprises a temperature sensor associated with said hydraulic circuit and operatively connected with the processing unit and wherein the processing unit is configured to deactivate said operating condition in response to the achievement of a first predetermined temperature value measured by said temperature sensor.
